(19) United States
(12) Patent Application Publication
(10) Pub. No.: US 2016/0077544 A1
(43) Pub. Date: Mar. 17, 2016

(54) CLOCK GATING CIRCUITS AND CIRCUIT ARRANGEMENTS INCLUDING CLOCK GATING CIRCUITS

(71) Applicant: Taiwan Semiconductor Manufacturing Company, Ltd., Hsin-Chu (TW)

(72) Inventors: Jiann-Tyng Tzeng, Hsin-Chu (TW); Meng-Hung Shen, Zhubei City (TW); Yi-Feng Chen, Xinpu Township (TW); Charles Chew-Yuen Young, Cupertino, CA (US)

(21) Appl. No.: 14/488,588

(22) Filed: Sep. 17, 2014

(51) Int. Cl. G06F 1/08

(52) U.S. Cl. CPC G06F 1/08

(57) ABSTRACT

Clock gating circuits may include: a first inverter; a first switch having a first terminal and a second terminal, the first terminal of the first switch coupled to an output of the first inverter; a feedback circuit having an input-output terminal, the input-output terminal of the feedback circuit coupled to the second terminal of the first switch; and a first logic gate having a first input terminal and a second input terminal, the first input terminal coupled to the input-output terminal of the feedback circuit, the second input terminal electrically connected to receive a master clock signal.

### BACKGROUND

Dynamic power consumption is an ongoing concern for integrated circuit (IC) devices, especially with ever-increasing clock frequencies used in synchronous IC devices. For some IC devices, more than half of the total dynamic power consumption may be attributed to clock distribution networks.

One technique to reduce the dynamic power consumption of clock distribution networks is to employ clock-gating circuits (CGCs) that selectively gate a number of clock signals on the IC device. More specifically, CGCs may reduce power consumption by selectively pruning an IC device's clock tree or clock distribution network, thereby disabling portions of the clock tree or clock distribution network so that some circuit elements such as latches and/or flip-flops do not switch between logic high and low states. Preventing such latches and/or flip-flops from toggling between logic states may significantly reduce dynamic power consumption of the IC device. Unfortunately, many conventional clock-gating circuits consume an undesirable amount of dynamic power, even when portions of the clock tree or clock distribution network are disabled.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A shows a schematic of a clock gating circuit.

FIG. 1B shows circuitry of the clock gating circuit of FIG. 1A.

FIG. 2A shows a schematic of a clock gating circuit, in accordance with some embodiments.

FIG. 2B shows circuitry of the clock gating circuit of FIG. 2A, in accordance with some embodiments.

FIG. 3 shows a digital logic block including at least one of the clock gating circuits shown in FIGS. 2A and 2B, in accordance with some embodiments.

### DETAILED DESCRIPTION

The following disclosure provides many different embodiments, or examples, for implementing different features of the provided subject matter. Specific examples of components and stacks are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, the terms “coupled” or “connected” means at least either a direct electrical connection between the devices connected or an indirect connection through one or more passive intermediary devices. The term “circuit” means at least either a single component or a multiplicity of passive components, that are connected together to provide a desired function. The term “signal” means at least one current, voltage, charge, data, or other signal.

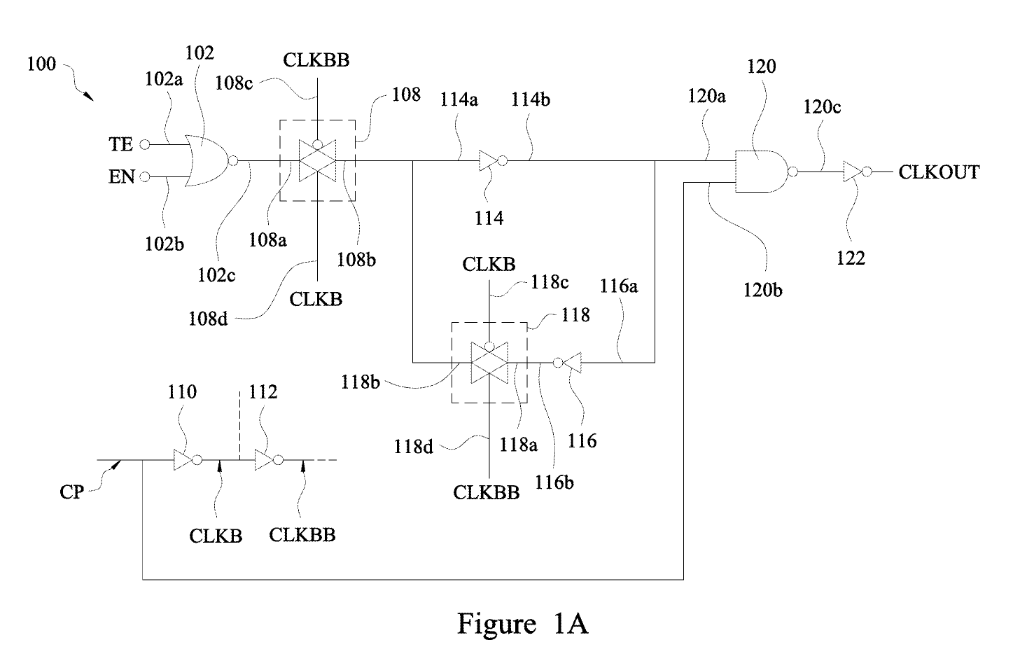

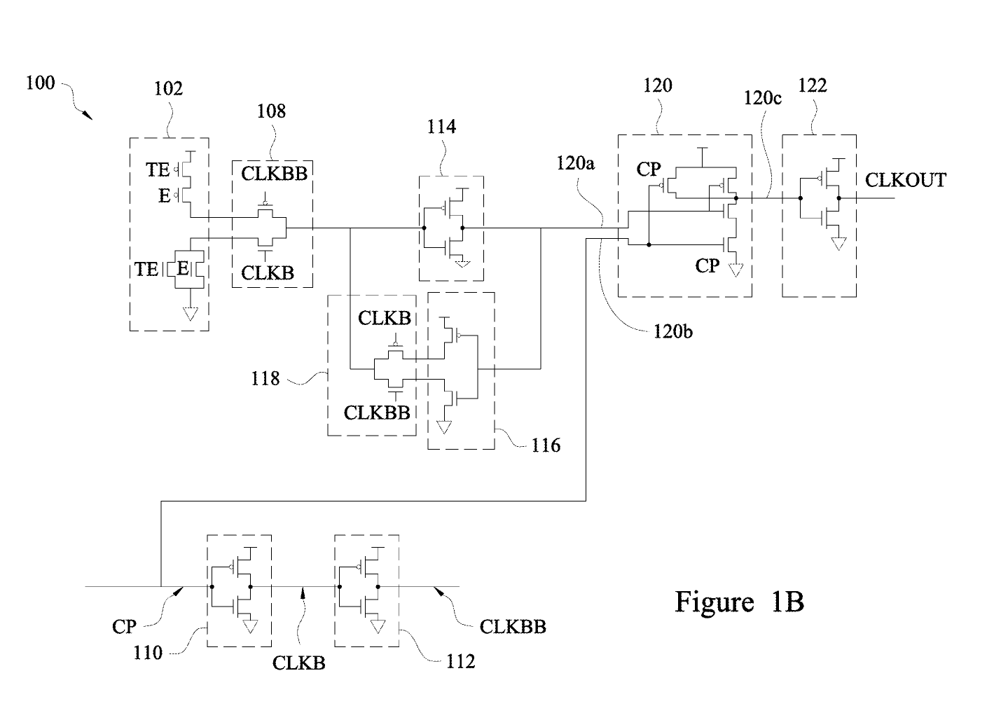

FIG. 1A shows a schematic of a clock gating circuit (CGC) 100. The CGC 100 can be used to reduce dynamic power consumption in an integrated circuit (IC) device by preventing one or more IC device elements (e.g. latches or flip flops) of the IC device from switching between logic states. This may be accomplished by connecting the CGC 100 between a master clock signal and the one or more IC device elements, and by allowing the master clock signal to pass through (e.g. gated through) the CGC 100 to the one or more IC device elements when the CGC 100 is enabled or activated. On the other hand, when the CGC 100 is disabled or deactivated, the output of the CGC 100 may be held constant at a high state (e.g. logic 1) or a low state (e.g. logic 0). The constant level of the output of the CGC 100 may prevent the toggling of the one or more IC device elements coupled to the CGC 100, which in turn may prevent the one or more IC device elements from switching between logic states, thus reducing dynamic power consumption in the IC device.

The CGC 100 may include a NOR gate 102 having a first input 102a, a second input 102b, and an output 102c. The NOR gate 102 receives a test enable signal TE and an enable signal EN at the first input 102a and the second input 102b, respectively. The NOR gate 102 may be coupled to a first transmission gate 108. In particular, the output 102c of the NOR gate 102 may be coupled to an input 108a of the first transmission gate 108. The first transmission gate 108 may function as a switch (e.g. an analog switch) and may be controlled by a first control signal CLKBB and a second control signal CLKB, which are received at an inverting control terminal 108c and a control terminal 108d of the first transmission gate 108, respectively.

When the first control signal CLKBB is at logic 0, the first transmission gate 108 may be in a conducting state, and the logic state at the input 108a may be passed through the first transmission gate 108 to an output 108b of the first transmission gate 108. Accordingly, the first transmission gate 108 may function as a closed switch (e.g. closed analog switch) when the first control signal CLKBB is at logic 0. However, when the first control signal CLKBB is at logic 1, the first transmission gate 108 may be in a high impedance state, and the logic state at the input 108a may be prevented from passing through the first transmission gate 108 to the output 108b. Accordingly, the first transmission gate 108 may function as an open switch (e.g. open analog switch) when the first control signal CLKBB is at logic 1. Therefore, the first transmission gate 108 may selectively block or pass a signal from the input 108a to the output 108b.

As shown in FIG. 1A, the CGC 100 may include a first inverter 110 and a second inverter 112. The second control signal CLKB may be generated by passing a master clock signal CP through the first inverter 110, while the first control signal CLKBB may be generated by passing the second control signal CLKB through the second inverter 112 coupled in series with the first inverter 110, as shown in FIG. 1A. Accordingly, the first control signal CLKBB and the second control signal CLKB may be toggling control signals that may toggle at substantially the same rate as the master clock signal CP.

The first transmission gate 108 may be coupled to a third inverter 114. In particular, an output 108b of the first transmission gate 108 may be coupled to an input 114a of the third inverter 114, as shown in FIG. 1A. The third inverter 114 may be coupled in parallel to a series connection of a fourth inverter 116 and a second transmission gate 118. For example, as shown in FIG. 1A, an output 114b of the third inverter 114 may be coupled to an input 116a of the fourth inverter 116 whose output 116b is coupled to an input 118a of the second transmission gate 118. An output 118b of the second transmission gate 118 may, in turn, be coupled to the input 114a of the third inverter 114, as shown in FIG. 1A.

The second transmission gate 118 may function as a switch (e.g. an analog switch) and may be controlled by the first control signal CLKBB and the second control signal CLKB. However, in the case of the second transmission gate 118, the second control signal CLKB may be received an inverting control terminal 118c of the second transmission gate 118, while the first control signal CLKBB may be received at a control terminal 118d of the second transmission gate 118.

When the first control signal CLKBB is at logic 0, the second transmission gate 118 may be in a high impedance state, and the logic state at the input 118a may be prevented from passing through the second transmission gate 118 to the output 118b. Accordingly, the second transmission gate 118 may function as an open switch (e.g. open analog switch) when the first control signal CLKBB is at logic 0. However, when the first control signal CLKBB is at logic 1, the second transmission gate 118 may be in a conducting state, and the logic state at the input 118a may be passed through the second transmission gate 118 to the output 118b. Accordingly, the second transmission gate 118 may function as a closed switch (e.g. closed analog switch) when the first control signal CLKBB is at logic 1. Therefore, the second transmission gate 118 may selectively block or pass a signal from the input 118a to the output 118b.

Consequently, when the first control signal CLKBB is at a particular logic state (e.g. logic 1 or logic 0), either the first transmission gate 108 or the second transmission gate 118 allows passage of a logic state at its respective input to its respective output. In other words, if the first transmission gate 108 allows the passage of a logic state from its input to its output, then the second transmission gate 118 prevents the passage of a logic state from its input to its output. Conversely, if the first transmission gate 108 prevents the passage of a logic state from its input to its output, then the second transmission gate 118 allows the passage of a logic state from its input to its output. Stated in yet another way, the first transmission gate 108 (functioning as a first switch) and the second transmission gate 118 (functioning as a second switch) may operate in opposition to each other.

As shown in FIG. 1A, the CGC 100 may further include a NAND gate 120 having a first input 120a, a second input 120b, and an output 120c. The first input 120a of the NAND gate 120 may be coupled to the output 114b of the third inverter 114, while the second input 120b may be coupled to the master clock signal CP. The output 120c of the NAND gate 120 may be coupled to a fifth inverter 122, which generates a clock output CLKOUT.

In the operation of the CGC 100, the enable signal EN may be at logic 1 and the test enable signal TE may be at logic 0. Consequently, the output 102c of the NOR gate may be at logic 0. The input 108a of the first transmission gate 108 receives the logic 0 from the output 102c of the NOR gate 102. When the first control signal CLKBB is at logic 0, the first transmission gate 108 may conduct, thus enabling the logic 0 at the input 108a of the first transmission gate 108 to propagate to the output 108b of the first transmission gate 108. The third inverter 114 receives the logic 0 from the output 108b of the first transmission gate 108 and generates a logic 1 at its output 114b. The logic 1 at the output 114 of the third inverter 114 is passed to the input 116a of the fourth inverter 116, which, in turn, generates a logic 0 at its output 116b. The logic 0 at the output 116b of the fourth inverter 116 is passed to the input 118a of the second transmission gate 118. Since the first control signal CLKBB is at logic 0, the second transmission gate 118 may be in a high impedance state and may not allow passage of the logic 0 at its input 118a to its output 118b. However, when the first control signal CLKBB switches from logic 0 to logic 1, the second transmission gate 118 may be switch from the high impedance state to a conducting state (while the first transmission gate 108 may be switched from the conducting state to a high impedance state), thus enabling the logic 0 at the input 118a of the second transmission gate 118 to propagate to the output 118b of the second transmission gate 118. The logic 0 at the output 118b of the second transmission gate 118 may be passed to the input 114a of the third inverter 114, which subsequently generates a logic 1 at its output 114b.

Accordingly, the logic state at the input 114a of the third inverter 114 is passed back to the input 114a through an electrical path including the third inverter 114, fourth inverter 116, and second transmission gate 118. Since the enable signal EN and test enable signal TE may be provided to the NOR gate 102 at any time while the first control signal CLKBB is at logic 0 (e.g. at any time between a falling edge of the first control signal CLKBB and a rising edge of the first control signal CLKBB immediately following the falling edge), the electrical path including the third inverter 114, fourth inverter 116, and second transmission gate 118 may serve to synchronize the logic state at the input 114a of the third inverter 114 with the first control signal CLKBB and the second control signal CLKB.

The logic 1 at the output 114b of the third inverter 114 is subsequently passed to the first input 120a of the NAND gate 120. When the master clock signal CP is at logic 0, the NAND gate 120 generates a logic 1 at its output 120c, and the fifth inverter 122 outputs a logic 0 as the clock output CLKOUT. On the other hand, when the master clock signal CP is at logic 1, the NAND gate 120 generates a logic 0 at its output 120c, and the fifth inverter 122 outputs a logic 1 as the clock output CLKOUT. Consequently, the clock output CLKOUT mimics the logic state of the master clock signal CP when the CGC 100 is enabled (e.g. when the enable signal EN is at logic 1). In other words, when the CGC 100 is enabled, the master clock signal CP is allowed to pass through (e.g. gated through) the CGC 100 to the one or more IC device elements that may receive the clock output CLKOUT from the CGC 100.

Conversely, when the CGC 100 is disabled (e.g. when the enable signal EN is at logic 0), the master clock signal CP is prevented from passing through (e.g. gated through) the CGC 100 to the one or more IC device elements that may receive the clock output CLKOUT from the CGC 100. In such an example, the clock output CLKOUT may be held at a constant level (e.g. at logic 0 or at logic 1), thus preventing the toggling of the one or more IC device elements that may receive the clock output CLKOUT from the CGC 100. For example, in operation of the CGC 100, the enable signal EN and the test enable signal TE may be at logic 0. Accordingly, the output 102c of the NOR gate 102 may be at logic 1. The logic 1 at the output 102c of the NOR gate 102 passes through the first transmission gate 108 when the first control signal CLKBB is at logic 0, is synchronized to the first control signal CLKBB and the second control signal CLKB by the electrical path including the third inverter 114, the fourth inverter 116, and the second transmission gate 118 when the first control signal CLKBB is at logic 1. The synchronized signal (which is at logic 1) is subsequently passed to the input 114a of the third inverter 114. In response, the third inverter 114 generates a logic 0 at the output 114b, which is then passed to the first input 120a of the NAND gate 120. When the master clock signal CP is at logic 0, the NAND gate 120 generates a logic 1 at its output 120c, and the fifth inverter 122 outputs a logic 0 as the clock output CLKOUT. When the master clock signal CP is at logic 1, the NAND gate 120 generates a logic 1 at its output 120c, and the fifth inverter 122 outputs a logic 0 as the clock output CLKOUT. Consequently, in the CGC 100 shown in FIG. 1A, the clock output CLKOUT is held constant at logic 0 when the CGC 100 is disabled (e.g. when the enable signal EN is at logic 0). Therefore, the one or more IC device elements that may receive the clock output CLKOUT from the CGC 100 are prevented from toggling.

FIG. 1B shows a diagram illustrating the circuitry of the CGC 100 shown in FIG. 1A. As shown in FIG. 1B, the CGC 100 may be implemented using p-type metal-oxide-semiconductor (PMOS) and n-type metal-oxide-semiconductor (NMOS) transistors. For example, the first transmission gate 108, the second transmission gate 118, the first inverter 110, the second inverter 112, the third inverter 114, the fourth inverter 116, and the fifth inverter 116 may each be implemented using one PMOS transistor and one NMOS transistor. Furthermore, the NOR gate 102 and the NAND gate 120 may each be implemented using two PMOS transistors and two NMOS transistors. Consequently, the CGC 100 shown in FIGS. 1A and 1B may include a total of 22 transistors (e.g. 11 PMOS transistors and 11 NMOS transistors). As shown in FIG. 1A, the gates of PMOS transistor and the NMOS transistor of the first transmission gate 108 are biased in a complementary manner so that both the PMOS transistor and the NMOS transistor are either conducting or non-conducting. A similar arrangement is seen for the second transmission gate 118.

Of the 22 transistors of the CGC 100, the gates of ten transistors may receive a toggling signal when the enable signal EN is at logic 1 as well as when the enable signal EN is at logic 0. In other words, the gates of ten transistors receive a toggling signal whether the CGC 100 is enabled or disabled. For example, the gate of the PMOS transistor of the first transmission gate 108 and the gate of the NMOS transistor of the second transmission gate 118 receive the first control signal CLKBB, which, as described above, may toggle at substantially the same rate as the master clock signal CP. Furthermore, the gate of the NMOS transistor of the first transmission gate 108 and the gate of the PMOS transistor of the second transmission gate 118 receive the second control signal CLKB, which may toggle at substantially the same rate as the master clock signal CP. The toggling second control signal CLKB is also provided to the gates of the PMOS transistor and the NMOS transistor of the second inverter 112, as shown in FIG. 1B. Even further, the toggling master clock signal CP is provided to the gates of the PMOS transistor and the NMOS transistor of the first inverter 110 as well as to the gate of one PMOS transistor and the gate of one CMOS transistor of the NAND gate 120. It is noted that the master clock signal CP, the first control signal CLKBB, and the second control signal CLKB toggle between a high state and a low state whether the enable signal EN is at logic 0 or at logic 1.

While the CGC 100 may reduce dynamic power consumption of an IC device by preventing the toggling of the one or more circuit elements of the IC device coupled to the output of the CGC 100, the CGC 100 itself may consume power, and may contribute greatly to the overall power consumption of the IC device. The power consumption of the CGC 100 may be attributed to the 22 transistors included in the CGC 100. Of the power consumed by the 22 transistors of the CGC 100, most of the power may be consumed by the transistors that receive a toggling signal at their gates whether the CGC 100 is enabled or disabled, e.g. the ten transistors described above that receive the first control signal CLKBB, the second control signal CLKB, and the master clock signal CP at their gates.

Furthermore, inverter short-circuit power may be dissipated at the first inverter 110 and the second inverter 112 of CGC 100 when the second control signal CLKB and the first control signal CLKBB are generated from the master clock signal CP by the first inverter 110 and the second inverter 112, respectively. Accordingly, if the CGC 100 can be replaced with another CGC that provides the same functionality, but has a smaller total number of transistors as well as a smaller number of transistors that receive a toggling signal at their gates, the power consumed by the CGC may be reduced, which in turn, may reduce the dynamic power consumption of an IC device that includes one or more such CGCs.

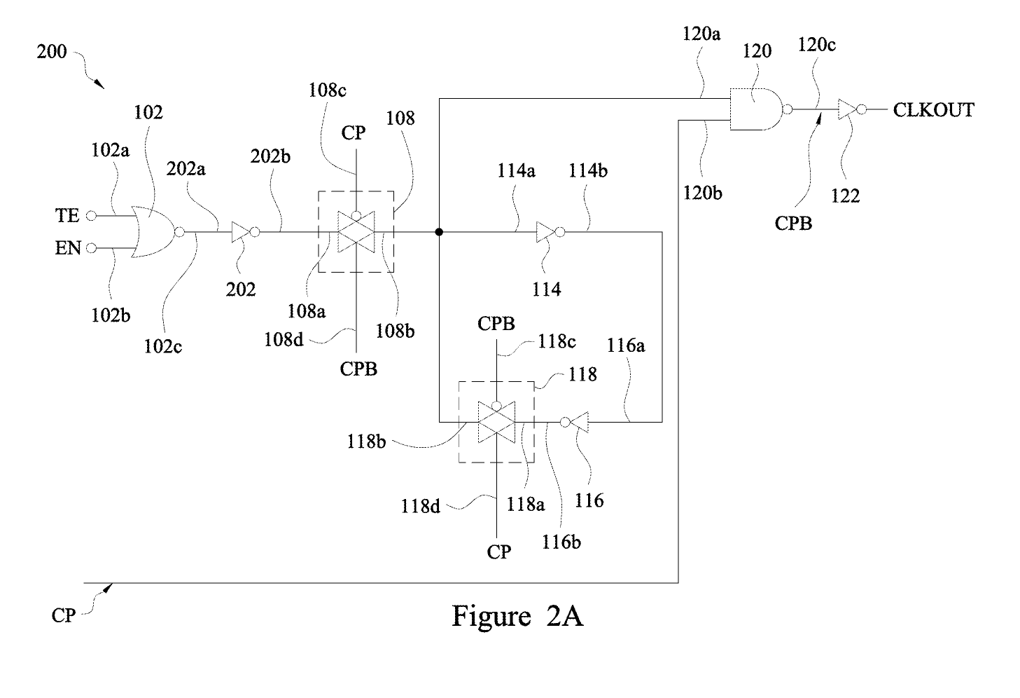

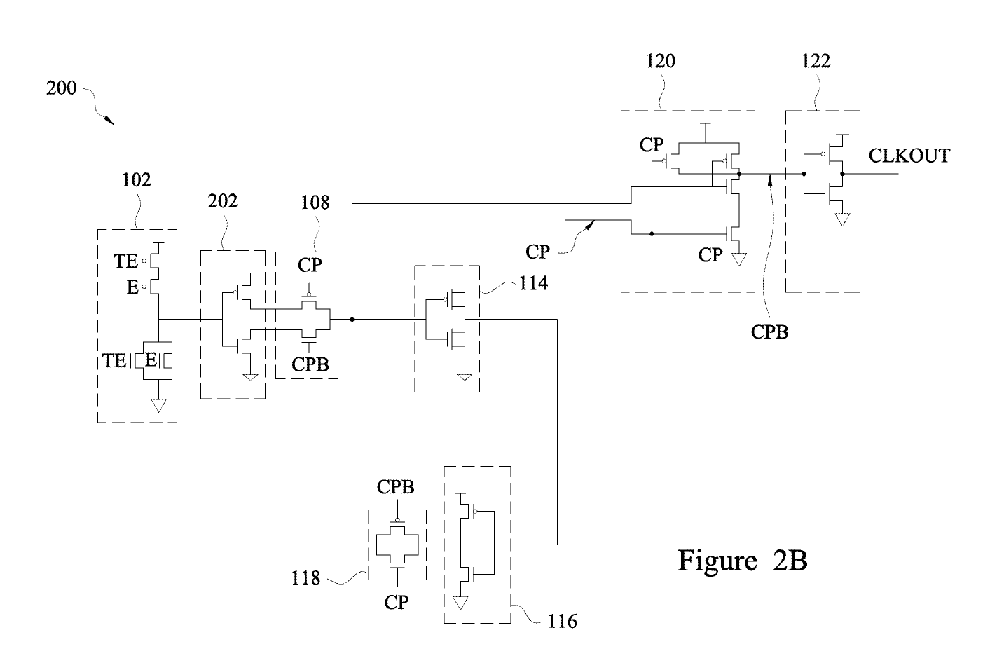

FIG. 2A shows a schematic of a CGC 200, in accordance with an embodiment, where the total number of transistors as well as the number of transistors that receive a toggling signal at their gates is reduced compared to the CGC 100 in FIGS. 1A and 1B. The CGC 200 shown in FIG. 2A may achieve the same functionality as the CGC 100 shown in FIG. 1A and FIG. 1B. The CGC 200 may include the NOR gate 102 having the first input 102a, the second input 102b, and the output 102c. The NOR gate 102 receives the test enable signal TE and the enable signal EN at the first input 102a and the second input 102b, respectively. The CGC 200 includes the first transmission gate 108. However, in the CGC 200 shown in FIG. 2A, the output 102c of the NOR gate 102 is coupled to the first transmission gate 108 through a sixth inverter 202. In other words, the sixth inverter 202 is coupled between the NOR gate 102 and the first transmission gate 108. In particular, the output 102c of the NOR gate 102 is coupled to an input 202a of the sixth inverter 202, and an output 202b of the sixth inverter 202 is coupled to the input 108a of the first transmission gate 108.

The first transmission gate 108 may be controlled by the master clock signal CP and an inverted master clock signal CPB, which may be generated by passing the master clock signal CP through the NAND gate 120, as shown in FIG. 2A. However, in contrast to the first control signal CLKBB and the second control signal CLKB shown in FIGS. 1A and 1B, the inverted master clock signal CPB toggles when the CGC 200 in enabled, but is held at a constant level (e.g. a logic 0 or a logic 1) when the CGC 200 is disabled. This is described in greater detail below in respect of the operation of the CGC 200. As shown in FIG. 2A, the master clock signal CPB may be received at the inverting control terminal 108c of the first transmission gate 108, while the inverted master clock signal CPB may be received at the control terminal 108d of the first transmission gate 108.

The first transmission gate 108 may be coupled to the third inverter 114. In particular, the output 108b of the first transmission gate 108 may be coupled to the input 114a of the third inverter 114. In the CGC 200, the third inverter 114 may be coupled in series with the fourth inverter 116 and the second transmission gate 118. For example, as shown in FIG. 2A, the output 114b of the third inverter 114 may be coupled to the input 116a of the fourth inverter 116 whose output 116b is, in turn, coupled to the input 118a of the second transmission gate 118. The output 118b of the second transmission gate 118 may, in turn, be coupled to the input 114a of the third inverter 114, as shown in FIG. 2A.

The second transmission gate 118 may be controlled by the master clock signal CP and the inverted master clock signal CPB. As shown in FIG. 2A, the master clock signal CPB may be received at the control terminal 118d of the second transmission gate 108, while the inverted master clock signal CPB may be received at the inverting control terminal 118c of the second transmission gate 118. As shown in FIG. 2A, when the master clock signal CP is at a particular logic state (e.g. logic 1 or logic 0), either the first transmission gate 108 or the second transmission gate 118 allows passage of a logic state at its respective input to its respective output. In other words, if the first transmission gate 108 allows the passage of a logic state from its input to its output, then the second transmission gate 118 prevents the passage of a logic state from its input to its output. Conversely, if the first transmission gate 108 prevents the passage of a logic state from its input to its output, then the second transmission gate 118 allows the passage of a logic state from its input to its output. Stated in yet another way, the first transmission gate 108 (functioning as a first switch) and the second transmission gate 118 (functioning as a second switch) may operate in opposition to each other.

As shown in FIG. 2A, the CGC 200 may further include the NAND gate 120 having the first input 120a, the second input 120b, and the output 120c. The first input 120a may be coupled to the output 118b of the second transmission gate 118, while the second input 120b may be coupled to the master clock signal CP. The output 120c of the NAND gate 120 may be coupled to the fifth inverter 122, which may generate the clock output CLKOUT.

In the operation of the CGC 200, the enable signal EN may be at logic 1 and the test enable signal TE may be at logic 0. Consequently, the output 102c of the NOR gate may be at logic 0. The input 202a of the sixth inverter 202 receives the logic 0 from the output 102c of the NOR gate 102, and in response, the sixth inverter 202 generates a logic 1 at the output 202b. The input 108a of the first transmission gate 108 receives the logic 1 from the output 202b of the sixth inverter. When the master clock signal CP is at logic 0, the first transmission gate 108 conducts, thus enabling the logic 1 at the input 108a of the first transmission gate 108 to propagate to the output 108b of the first transmission gate 108. The third inverter 114 receives the logic 1 from the output 108b of the first transmission gate 108 and generates a logic 0 at its output 114b. The logic 0 at the output 114 of the third inverter 114 is passed to the input 116a of the fourth inverter 116, which, in turn, generates a logic 1 at its output 116b. The logic 1 at the output 116b of the fourth inverter 116 is passed to the input 118a of the second transmission gate 118. Since the master clock signal CP is at logic 0, the second transmission gate 118 is in a high impedance state and does not allow passage of the logic 1 from its input 118a to its output 118b. However, when the master clock signal CP switches from logic 0 to logic 1, the second transmission gate 118 switches from the high impedance state to a conducting state (while the first transmission gate 108 switches from the conducting state to a high impedance state), thus enabling the logic 1 at the input 118a of the second transmission gate 118 to propagate to the output 118b of the second transmission gate 118. The logic 1 at the output 118b of the second transmission gate 118 is passed to the first input 120a of the NAND gate 120. Accordingly, the logic state at the input 114a of the third inverter 114 is passed back to the input 114a through an electrical path including the third inverter 114, fourth inverter 116, and second transmission gate 118. The electrical path including the third inverter 114, fourth inverter 116, and second transmission gate 118 may also be referred to as a feedback circuit, which may function as a signal latch (e.g. to store a logic state or synchronize a logic state with a clock signal). In this regard, the feedback circuit may include an input-output terminal, which may be represented by the input 114a of the third inverter 114 and/or the output 118b of the second transmission gate 118.

Since the enable signal EN and test enable signal TE may be provided to the NOR gate 102 at any time while the master clock signal CP is at logic 0 (e.g. at any time between a falling edge and an immediately following rising edge of the master clock signal CP), the feedback circuit (e.g. combination of the third inverter 114, fourth inverter 116, and second transmission gate 118) may serve to synchronize the logic state at the input 114a of the third inverter 114 with the master clock signal CP. Accordingly, the electrical path including the third inverter 114, fourth inverter 116, and second transmission gate 118 may also be referred to as a synchronization circuit.

Referring back to the logic 1 at the first input 120a of the NAND gate 120, when the master clock signal CP is at logic 0, the NAND gate 120 generates a logic 1 at its output 120c. On the other hand, when the master clock signal CP is at logic 1, the NAND gate 120 generates a logic 0 at its output 120c. Consequently, as described above, when the CGC 200 is enabled, the inverted master clock signal CPB (which is produced at the output 120c of the NAND gate 120) acts as a toggling control signal that is provided to the first transmission gate 108 and the second transmission gate 118. The fifth inverter 122 outputs a logic 0 as the clock output CLKOUT when the inverted master clock signal CPB is at logic 1, and outputs a logic 1 as the clock output CLKOUT when the inverted master clock signal CPB is at logic 0. Consequently, the clock output CLKOUT mimics the logic state of the master clock signal CP when the CGC 200 is enabled (e.g. when the enable signal EN is at logic 1). Therefore, when the CGC 200 is enabled, the master clock signal CP is allowed to pass through (e.g. gated through) the CGC 200 to the one or more IC device elements that may receive the clock output CLKOUT from the CGC 200. Accordingly, the CGC 200 provides the same functionality as the CGC 100 when enabled.

Conversely, when the CGC 200 is disabled (e.g. when the enable signal EN is at logic 0), the master clock signal CP is prevented from passing through (e.g. gated through) the CGC 200 to one or more IC device elements that may receive the clock output CLKOUT from the CGC 200. In such an example, the clock output CLKOUT may be held at a constant level (e.g. at logic 0 or at logic 1), thus preventing the toggling of the one or more IC device elements. For example, in operation of the CGC 200, the enable signal EN and the test enable signal TE may be at logic 0. Accordingly, the output 102c of the NOR gate 102 may be at logic 1. The logic 1 at the output 102c of the NOR gate 102 is passed to the sixth inverter 202, which generates a logic 0 at its output 202b. The logic 0 is then passed through the first transmission gate 108 when the master clock signal CP is at logic 0, is synchronized to the master clock signal CP by the electrical path including the third inverter 114, the fourth inverter 116, and the second transmission gate 118 when the master clock signal CP is at logic 1. The synchronized signal (which is at logic 0) is subsequently provided to the input 120a of the NAND gate 120.

When the master clock signal CP is at logic 0, the NAND gate 120 generates a logic 1 at its output 120c. On the other hand, when the master clock signal CP is at logic 1, the NAND gate 120 still generates a logic 1 at its output 120c. Consequently, as described above, when the CGC 200 is disabled, the inverted master clock signal CPB is held at a constant level (which in this example is logic 1), and thus, does not act as a toggling control signal for the first transmission gate 108 and the second transmission gate 118. Since the inverted master clock signal CPB is held constant at logic 1 when the CGC 200 is disabled, the fifth inverter 122 outputs a logic 0 as the clock output CLKOUT. Consequently, in the CGC 200 shown in FIGS. 2A and 2B, the clock output CLKOUT is held constant at logic 0 when the CGC 200 is disabled (e.g. when the enable signal EN is at logic 0). Therefore, the one or more IC device elements that may receive the clock output CLKOUT from the CGC 200 are prevented from toggling between logic states. Accordingly, the CGC 200, when disabled, provides the same functionality as the CGC 100, when disabled.

FIG. 2B shows a diagram illustrating the circuitry of the CGC 200 shown in FIG. 2A. As shown in FIG. 2B, the CGC 200 may be implemented using p-type metal-oxide-semiconductor (PMOS) and n-type metal-oxide-semiconductor (NMOS) transistors. For example, the first transmission gate 108, the second transmission gate 118, the third inverter 114, the fourth inverter 116, the fifth inverter 116, and the sixth inverter 202 may each be implemented using one PMOS transistor and one NMOS transistor. Furthermore, the NOR gate 102 and the NAND gate 120 may each be implemented using two PMOS transistors and two NMOS transistors. Consequently, the CGC 200 shown in FIGS. 2A and 2B may include a total of 20 transistors (e.g. 10 PMOS transistors and 10 NMOS transistors). As shown in FIG. 2B, the gates of PMOS transistor and the NMOS transistor of the first transmission gate 108 are biased in a complementary manner so that both the PMOS transistor and the NMOS transistor are either conducting or non-conducting. A similar arrangement is seen for the second transmission gate 118.

Of the 20 transistors of the CGC 200, the gates of four transistors may receive a toggling signal when the enable signal EN is at logic 1 as well as when the enable signal EN is at logic 0. In other words, the gates of four transistors receive a toggling signal whether the CGC 200 is enabled or disabled. For example, the gate of the PMOS transistor of the first transmission gate 108 and the gate of the NMOS transistor of the second transmission gate 118 receive the master clock signal CP whether the CGC 200 is enabled or disabled. Furthermore, the master clock signal CP is provided to one PMOS transistor and the gate of one CMOS transistor of the NAND gate 120 whether the CGC 200 is enabled or disabled. It is once again noted that the inverted master clock signal CPB is held constant when the CGC 200 is disabled.

As shown in FIGS. 2A and 2B, even though the sixth inverter 202 is included in the CGC 200 and not in the CGC 100, by using the NAND gate 120 to generate the inverted master clock signal CPB, the first inverter 110 and the second inverter 112 may be excluded from the CGC 200, thus decreasing the total number of transistors in the CGC 200. As described above, the total number of transistors in the CGC 200 is 20 transistors, while the total number of transistors in the CGC 100 is 22 transistors. This represents a 9% reduction in the total number of transistors in the CGC 200 compared to the CGC 100. This in turn results in lower power consumption in the CGC 200 compared to the CGC 100, which in turn, may reduce the dynamic power consumption of an IC device that includes one or more such CGCs 200.

Furthermore, the number of transistors whose gates receive a toggling control signal whether the CGC is enabled or disabled is reduced from 10 in the CGC 100 of FIGS. 1A and 1B to 4 in the CGC 200 of FIGS. 2A and 2B. This represents a 60% reduction in the number of transistors whose gates receive a toggling control signal whether the CGC is enabled or disabled. This in turn results in lower power consumption in the CGC 200 compared to the CGC 100, which in turn, may reduce the dynamic power consumption of an IC device that includes one or more such CGCs 200.

In addition to the power saved by reducing the total number of transistors and the number of transistors whose gates receive a toggling input, the inverter short-circuit power dissipation observed in the first transistor 110 and the second transistor 112 of the CGC 100 is also eliminated since the first transistor 110 and the second transistor 112 are excluded from the CGC 200. Even further, the area used to implement the CGC 200 is smaller compared to the area used to implement the CGC 100. This is a result of the reduced total number of transistors in the CGC 200. In spite of this, neither the functionality nor the robustness of the CGC 200 is compromised. Moreover, the CGC 200 does not include dynamic logic circuitry, thereby avoiding the introduction of new failure mechanisms in the CGC 200.

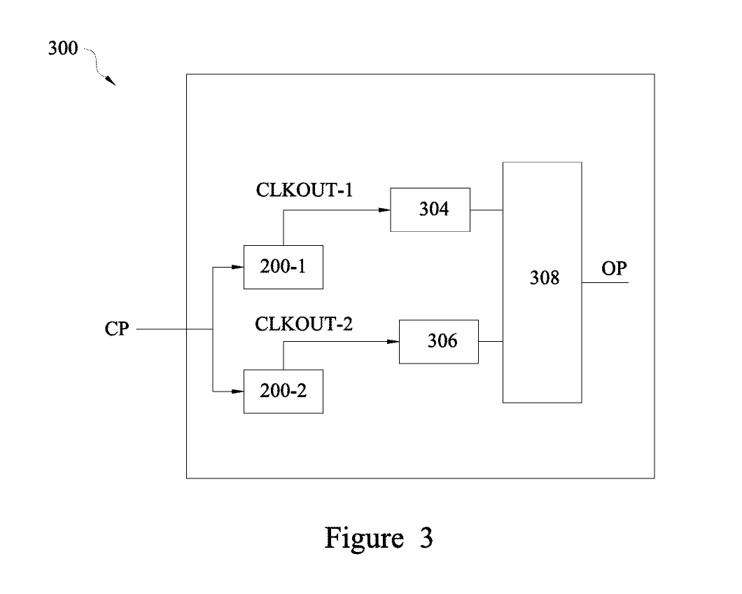

FIG. 3 shows a schematic of a digital logic block 300 in accordance with an embodiment. The digital logic block 300 may include a plurality of the CGCs 200-1, 200-2. Each of the CGCs of the plurality of CGCs 200-1, 200-2 may be the CGC 200 shown in FIGS. 2A and 2B. In the embodiment shown in FIG. 3, only two CGCs 200-1, 200-2 are shown as an example, however, the number of CGCs may be less than two (e.g. one) or may be more than two (e.g. three, four, five, six, or more) in accordance with other embodiments. The digital logic block 300 may include a first circuit element 304 that may be coupled to a first CGC 200-1 of the plurality of CGCs 200-1, 200-2. The first circuit element 304 may include at least one flip flop and/or at least one latch, as an example. As a further example, the first circuit element 304 may include another device or circuit element that may receive a clock signal.

The digital logic block 300 may further include a second circuit element 306 that may be coupled to a second CGC 200-2 of the plurality of CGCs 200-1, 200-2. The second circuit element 306 may include at least one flip flop and/or at least one latch, as an example. As a further example, the second circuit element 306 may include another device or circuit element that may receive a clock signal.

The digital logic block 300 may also include a combinational logic block 308 connected to the first circuit element 304 and the second circuit element 306 and may be used in conjunction with synchronous modules or a plurality of synchronous modules (not shown in FIG. 3) in an IC. These synchronous modules may include multiplexers, communication ports, processors, storage elements, and the like. The digital logic block 300 may receive the master clock signal CP, which may be provided to the plurality of CGCs 200-1, 200-2. Furthermore, as shown in FIG. 3, the digital logic block 300 may generate an output OP from the combinational logic block 308.

In operation of the digital logic block 300, a first enable signal EN-1 may be provided to the first CGC 200-1 and a second enable signal EN-2 may be provided to the second CGC 200-2. Depending on the logic state of the first enable signal EN-1, the first CGC 200-1 may be enabled or disabled. In the case where the first enable signal EN-1 enables the first CGC 200-1, the master clock signal CP may be received by the first CGC 200-1 and a first clock output CLKOUT-1, which mimics the master clock signal CP1, may be generated at the output of the first CGC 200-1. The first clock output CLKOUT-1 may subsequently be provided to the first circuit element 304, causing the first circuit element 304 to toggle between logic states. However, in the case where the first enable signal EN-1 disables the first CGC 200-1, the first clock output CLKOUT-1 generated at the output of the first CGC 200-1 may be held constant at a logic 0. This first clock output CLKOUT-1 that is subsequently provided to the first circuit element 304 may prevent the first circuit element 304 from toggling between logic states.

Similarly, depending on the logic state of the second enable signal EN-2, the second CGC 200-2 may be enabled or disabled. In the case where the second enable signal EN-2 enables the second CGC 200-2, the master clock signal CP may be received by the second CGC 200-2 and a second clock output CLKOUT-2, which mimics the master clock signal CP1, may be generated at the output of the second CGC 200-2. The second clock output CLKOUT-2 may subsequently be provided to the second circuit element 306, causing the second circuit element 306 to toggle between logic states. However, in the case where the second enable signal EN-2 disables the second CGC 200-2, the second clock output CLKOUT-2 generated at the output of the second CGC 200-2 may be held constant at a logic 0. This second clock output CLKOUT-2 that is subsequently provided to the second circuit element 306 may prevent the second circuit element 306 from toggling between logic states.

Consequently, a clock tree or a clock distribution network of the digital logic block 300 is selectively pruned, thereby disabling portions of the clock tree or clock distribution network so that some circuit elements (e.g. the first circuit element 304 and/or the second circuit element 306) do not switch between logic high and low states. Preventing such circuit elements from toggling between logic states may significantly reduce dynamic power consumption of the digital logic block 300 and of an IC device that may include the digital logic block 300.

Furthermore, power consumption in the digital logic block 300 is further reduced by the fact that each of the first CGC 200-1 and the second CGC 200-2 includes a smaller total number of transistors and a smaller number of transistors whose gates receive a toggling input compared to the CGC 100. Furthermore, the inverter short-circuit power dissipation observed in the CGC 100 is also eliminated in the digital logic block 300.

According to an embodiment described herein, a clock gating circuit is provided. The clock gating circuit may include: a first inverter; a first switch having a first terminal and a second terminal, the first terminal of the first switch coupled to an output of the first inverter; a feedback circuit having an input-output terminal, the input-output terminal of the feedback circuit coupled to the second terminal of the first switch; and a first logic gate having a first input terminal and a second input terminal, the first input terminal coupled to the input-output terminal of the feedback circuit, the second input terminal electrically connected to receive a master clock signal.

According to another embodiment described herein, a clock gating circuit is provided. The clock gating circuit may include: a first inverter; a first transmission gate having a first terminal and a second terminal, the first terminal of the first transmission gate coupled to an output of the first inverter; a second inverter, an input of the second inverter coupled to the second terminal of the first transmission gate; a third inverter, an input of the third inverter coupled to an output of the second inverter; a second transmission gate having a first terminal and a second terminal, the first terminal of the second transmission gate coupled to an output of the third inverter, the second terminal of the second transmission gate coupled to the input of the second inverter; and a first logic gate having a first input terminal and a second input terminal, the first input terminal of the first logic gate coupled to the second terminal of the second transmission gate, the second input terminal of the first logic gate electrically connected to receive a master clock signal.

According to an embodiment described herein, a circuit arrangement is provided. The circuit arrangement may include: a clock gating circuit coupled to at least one flip flop. The clock gating circuit may include: a NOR gate; a first inverter, wherein an output terminal of the NOR gate is coupled to an input of the first inverter; a first switch having a first terminal and a second terminal, the first terminal of the first switch coupled to an output of the first inverter; a second inverter, an input of the second inverter coupled to the second terminal of the first switch; a third inverter, an input of the third inverter coupled to an output of the second inverter; a second switch having a first terminal and a second terminal, the first terminal of the second switch coupled to an output of the third inverter, the second terminal of the second switch coupled to the input of the second inverter; a NAND gate having a first input terminal and a second input terminal, the first input terminal of the NAND gate coupled to the second terminal of the second switch, the second input terminal of the NAND gate electrically connected to receive a master clock signal; and a fourth inverter, an input of the fourth inverter coupled to an output of the NAND gate. The at least one flip flop may be coupled to an output of the fourth inverter of the clock gating circuit.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A clock gating circuit comprising:
a first inverter;
a first switch having a first terminal and a second terminal, the first terminal of the first switch coupled to an output of the first inverter;
a feedback circuit having an input-output terminal, the input-output terminal of the feedback circuit coupled to the second terminal of the first switch; and
a first logic gate having a first input terminal and a second input terminal, the first input terminal coupled to the input-output terminal of the feedback circuit, the second input terminal electrically connected to receive a master clock signal.

2. The clock gating circuit of claim 1, wherein the first logic gate comprises a NAND gate.

3. The clock gating circuit of claim 1, wherein a first control terminal of the first switch is electrically connected to receive the master clock signal, and wherein a second control terminal of the first switch is coupled to an output of the first logic gate.

4. The clock gating circuit of claim 1, wherein the first switch comprises a first transmission gate.

5. The clock gating circuit of claim 1, wherein the feedback circuit comprises:
a second inverter, wherein the input-output terminal of the feedback circuit comprises an input of the second inverter;
a third inverter, wherein an input of the third inverter is coupled to an output of the second inverter; and
a second switch having a first terminal and a second terminal, the first terminal of the second switch coupled to an output of the third inverter, the second terminal of the second switch coupled to the input of the second inverter.

6. The clock gating circuit of claim 5, wherein the second switch comprises a second transmission gate.

7. The clock gating circuit of claim 5, wherein a first control terminal of the second switch is coupled to an output of the first logic gate, and wherein a second control terminal of the second switch is electrically connected to receive the master clock signal.

8. The clock gating circuit of claim 1, further comprising:
a second logic gate having an input terminal and an output terminal, the input terminal of the second logic gate electrically connected to receive an enable signal, the output terminal of the second logic gate coupled to an input of the first inverter.

9. The clock gating circuit of claim 8, wherein the second logic gate comprises a NOR gate.

10. The clock gating circuit of claim 1, further comprising:
a fourth inverter having an input coupled to an output of the first logic gate.

11. A clock gating circuit, comprising:
a first inverter;
a first transmission gate having a first terminal and a second terminal, the first terminal of the first transmission gate coupled to an output of the first inverter;
a second inverter, an input of the second inverter coupled to the second terminal of the first transmission gate;
a third inverter, an input of the third inverter coupled to an output of the second inverter;
a second transmission gate having a first terminal and a second terminal, the first terminal of the second transmission gate coupled to an output of the third inverter, the second terminal of the second transmission gate coupled to the input of the second inverter; and
a first logic gate having a first input terminal and a second input terminal, the first input terminal of the first logic gate coupled to the second terminal of the second transmission gate, the second input terminal of the first logic gate electrically connected to receive a master clock signal.

12. The clock gating circuit of claim 11, wherein a first control terminal of the first transmission gate is electrically connected to receive the master clock signal, and wherein a second control terminal of the first transmission gate is coupled to an output of the first logic gate.

13. The clock gating circuit of claim 12, wherein the first transmission gate comprises:
a first transistor having a first conductivity type;
a second transistor having a second conductivity type different from the first conductivity type,
wherein the first control terminal of the first transmission gate comprises a gate terminal of the first transistor, and wherein the second control terminal of the first transmission gate comprises a gate terminal of the second transistor.

14. The clock gating circuit of claim 13, wherein the first transistor comprises a p-type metal-oxide-semiconductor transistor, and wherein the second transistor comprises an n-type metal-oxide-semiconductor transistor.

15. The clock gating circuit of claim 11, wherein a first control terminal of the second transmission gate is coupled to an output of the first logic gate, and wherein a second control terminal of the second transmission gate is electrically connected to receive the master clock signal.

16. The clock gating circuit of claim 15, wherein the second transmission gate comprises:
a first transistor having a first conductivity type;
a second transistor having a second conductivity type different from the first conductivity type,
wherein the first control terminal of the second transmission gate comprises a gate terminal of the first transistor, and wherein the second control terminal of the second transmission gate comprises a gate terminal of the second transistor.

17. The clock gating circuit of claim 16, wherein the first transistor comprises a p-type metal-oxide-semiconductor transistor, and wherein the second transistor comprises an n-type metal-oxide-semiconductor transistor.

18. A circuit arrangement comprising:
a clock gating circuit comprising:
a NOR gate;
a first inverter, wherein an output terminal of the NOR gate is coupled to an input of the first inverter;
a first switch having a first terminal and a second terminal, the first terminal of the first switch coupled to an output of the first inverter;
a second inverter, an input of the second inverter coupled to the second terminal of the first switch;
a third inverter, an input of the third inverter coupled to an output of the second inverter;
a second switch having a first terminal and a second terminal, the first terminal of the second switch coupled to an output of the third inverter, the second terminal of the second switch coupled to the input of the second inverter;
a NAND gate having a first input terminal and a second input terminal, the first input terminal of the NAND gate coupled to the second terminal of the second switch, the second input terminal of the NAND gate electrically connected to receive a master clock signal; and
a fourth inverter, an input of the fourth inverter coupled to an output of the NAND gate; and
at least one flip flop coupled to an output of the fourth inverter of the clock gating circuit.

19. The circuit arrangement of claim 18, wherein a first control terminal of the first switch is electrically connected to receive the master clock signal, and wherein a second control terminal of the first switch is coupled to the output of the NAND gate.

20. The clock gating circuit of claim 18, wherein a first control terminal of the second switch is coupled to the output of the NAND gate, and wherein a second control terminal of the second switch is electrically connected to receive the master clock signal.
